(19) United States
(12) Patent Application Publication
(10) Pub. No.: US 2006/0168535 A1
(43) Pub. Date: Jul. 27, 2006

(54) Recording medium storing program to input and output data with two screens, and method and apparatus for inputting and outputting data with two screens

(75) Inventor: Toshio Oki, Misato (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/236,604

(22) Filed: Sep. 28, 2005

(30) Foreign Application Priority Data
Jan. 24, 2005 (JP) 2005-016169

(51) Int. Cl. G06F 17/00; G06F 3/00

(52) U.S. Cl. 715/761; 715/764

(57) ABSTRACT

An existing input and output system for inputting data via an emulator screen requires some degree of skill. A current mainstream web-browser-based input and output system that simply replaces such an existing system eliminates the advantage of various operations supported by the existing system. These input and output systems of different types are appropriately switched or simultaneously displayed depending upon the user or the usage environment. Two input and output screens on which a single system is operated are appropriately switched or simultaneously displayed by recording data input to a terminal and data received from the outside in a log file and storing the input data and the received data in display data storage parts for these two types of display screens.

### BACKGROUND OF THE INVENTION

1. Field of the Invention

The present invention generally relates to the field of data input and output with two screens. More specifically, the present invention relates to a method for allowing a computer to input and output data with two display screens of different types. The present invention further relates to a recording medium storing a program causing a computer to perform the method, and to an apparatus related to a computer reading and executing the program.

2. Description of the Related Art

In the airline and travel agency industries, so-called emulator-type systems for use in text-based command input using a command line are the mainstream for inputting and outputting data to and from airline reservation systems. This type of systems must be operated by operators having some degree of skill. On the other hand, browser systems using a web browser as a user interface are widely used as general systems for inputting and outputting data, particularly, data communicated via a network. This type of systems is advantageously operated even by an operator of low skill. In the airline and travel agency industries, it is desirable to provide a system that can be operated even by an operator not having high skill levels.

For example, Japanese Unexamined Patent Application Publication No. 2001-312442 discloses a method for accessing a legacy application from a web-browser-based input and output system.

However, if the interface is replaced by the web-browser interface, a problem still exists. Although the emulator-type input and output systems require high skill levels, they have high performance by nature and allow for various system operations for reservations, etc. The web-browser-based systems, on the other hand, provide simple input and output operations because of their functional features or their design for a wide range of users, and may provide insufficient functionality to provide full functions of the systems for reservations, etc. Due to these drawbacks, such web-browser-based systems may even inconvenience users having sufficient skill for operating emulator-type systems. Moreover, in a case where an expert in the system teaches novice users the operation of the system, it conveniences users that screens for the input and output systems of both the web browser type and the emulator type should be appropriately switched or simultaneously displayed.

### SUMMARY OF THE INVENTION

Accordingly, it is an object of the present invention to provide a method for allowing two input and output system screens on which a single system is operated to be appropriately switched or simultaneously displayed.

According to the present invention, there is provided a computer readable recording medium storing a program to input and output data with first and second display screens of different types. The program, when executed, causes a computer to perform a process including a first data entry step of receiving data input from the first screen; an input data recording step of recording the received data as input data in a log file that records input/output data; and a second display data storage step of retrieving the input data from the log file and storing the input data as second display data in a second display data storage part that stores data to be displayed on the second screen.

The process may further include an input data transmission step of transmitting the input data to other computers; a response data reception step of receiving response data which the other computers send back in response to the input data; a response data recording step of recording the response data in the log file; and a display response data storage step of retrieving the response data from the log file, storing the response data as first display response data in a first display data storage part that stores data to be displayed on the first screen, and storing the response data as second display response data in the second display data storage part.

The process may further include a display screen control step of selecting which to display on a display unit the first screen, the second screen, or both the first screen and the second screen; and a selection display step of displaying the screen selected in the display screen control step on the display unit by outputting the data stored in the first display data storage part to the first screen, by outputting the data stored in the second display data storage part to the second screen, or by outputting the data stored in the first display data storage part to the first screen and the data stored in the second display data storage part to the second screen.

According to the present invention, therefore, an input and output environment for a suitable system depending on the skill of the operator can be achieved.

### BRIEF DESCRIPTION OF THE DRAWINGS

FIG. 1 is a block diagram of a system according to the present invention;

FIG. 2 is a flowchart showing a process for inputting and outputting data with two screens;

FIG. 3 is a flowchart showing a process for inputting and outputting data with two screens;

FIGS. 4A and 4B are illustrations of log file statuses;

FIG. 5 is a browser screen displayed according to the flowchart shown in FIG. 2;

FIGS. 6A and 6B are a browser screen and an emulator screen displayed according to the flowchart shown in FIG. 2, respectively;

FIG. 7 is a dual-screen display view in which the browser screen and the emulator screen are simultaneously displayed according to the flowchart shown in FIG. 2;

FIG. 8 is an emulator screen displayed according to the flowchart shown in FIG. 3;

FIGS. 9A and 9B are a browser screen and an emulator screen displayed according to the flowchart shown in FIG. 3, respectively; and

FIG. 10 is a dual-screen display view in which the browser screen and the emulator screen are simultaneously displayed according to the flowchart shown in FIG. 3.

### DESCRIPTION OF THE PREFERRED EMBODIMENTS

An embodiment of the present invention will be described with reference to the drawings.

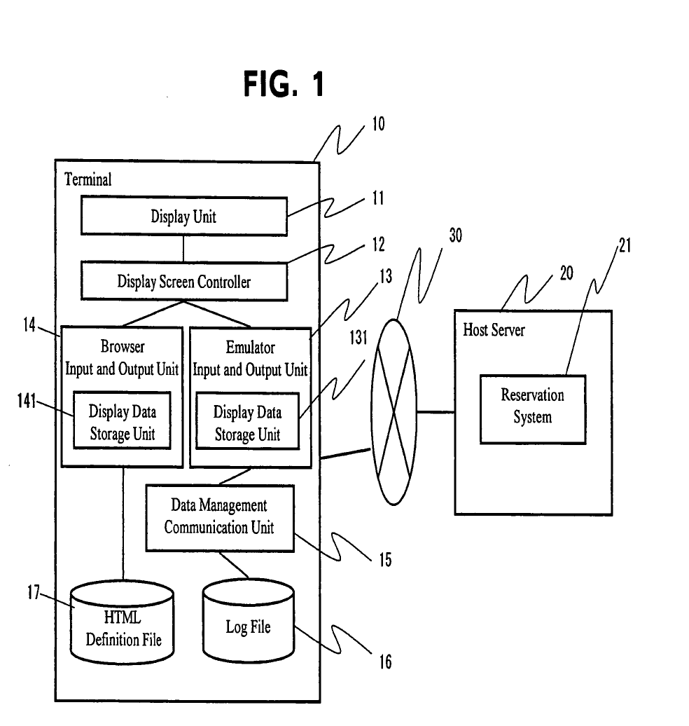

FIG. 1 shows the configuration of a system according to the present invention. The system shown in FIG. 1 has a configuration in which a terminal 10 and a host server 20 are connected via a network 30. The host server 20 includes a reservation system 21 for airline ticket reservations, inquiries, etc. The terminal 10 is operated to perform such reservations, etc. Although only one terminal 10 is shown in FIG. 1, a plurality of terminals are actually connected to the network 30, and these terminals communicate with the host server 20.

The terminal 10 includes a display unit 11, a display screen controller 12, an emulator input and output unit 13, a browser input and output unit 14, a data management communication unit 15, a log file 16, an HTML (hypertext markup language) definition file 17, and a field definition file 18. The emulator input and output unit 13 and the browser input and output unit 14 include display data storage units 131 and 141, respectively.

The display unit 10 outputs data received from the display screen controller 12 to a display device, such as a monitor device.

The display screen controller 12 receives display data on display screens transmitted from the emulator input and output unit 13 and the browser input and output unit 14, and transmits the display data on either display screen or both display screens to the display unit 10 according to setting from a user. The selected display data is displayed on the display device.

The emulator input and output unit 13 has functions for transmitting data input from an emulator screen to the data management communication unit 15 and storing it in the log file 16, receiving data read by the data management communication unit 15 from the log file 16 and storing it in the display data storage unit 131, and configuring display data on the emulator screen.

The browser input and output unit 14 has functions for transmitting data input from a browser screen to the data management communication unit 15 and storing it in the log file 16, receiving data read by the data management communication unit 15 from the log file 16 and storing it in the display data storage unit 141, and configuring display data on the browser screen. The display data on the browser screen is configured by referring to a predetermined HTML file stored in the HTML definition file 17 and converting the data retrieved from the log file 16 according to the format specified in the HTML file. The data input from the browser screen is also extracted according to the definition in the HTML file, and is recorded in the log file 16. This processing is generally known, and a description of the details thereof is thus omitted.

The data management communication unit 15 has functions for transmitting and receiving data to and from the reservation system 21, writing and reading data to and from the log file 16, and transmitting and receiving data to and from the emulator input and output unit 13 and the browser input and output unit 14.

The log file 16 records data input to the terminal 10 via the browser screen or the emulator screen or response data received from the reservation system 21.

The HTML definition file 17 stores HTML files to be used for configuring a browser screen, as described above.

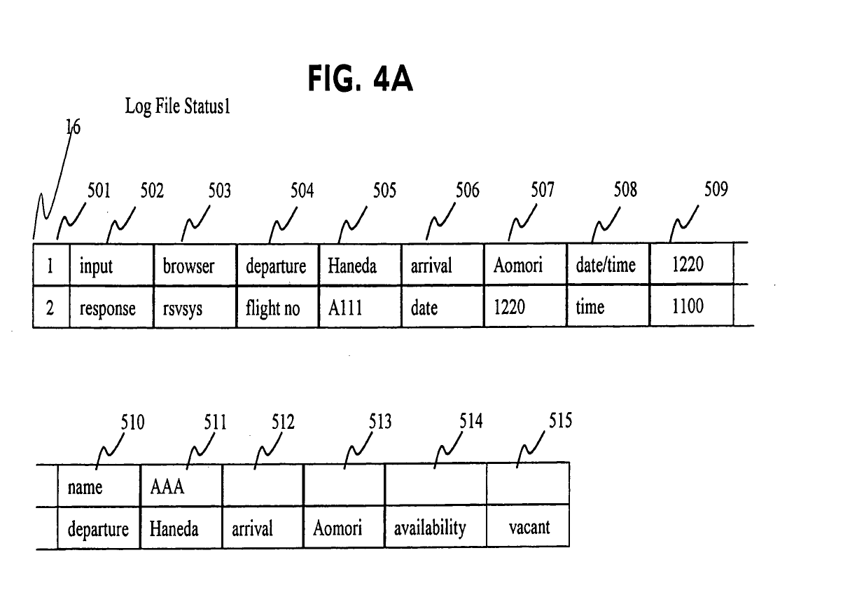

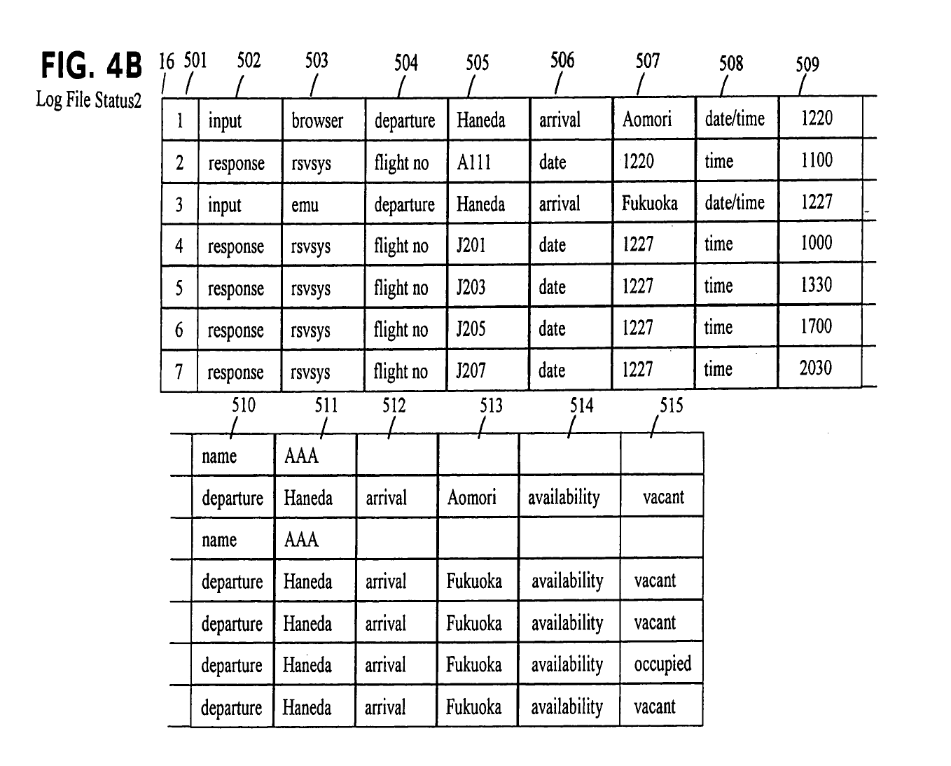

FIGS. 4A and 4B show entries in the log file 16. A column 501 indicates the line number. A column 502 indicates the data type, wherein “input” represents data input to the terminal 10 and “response” represents response data received from the reservation system 21 via the network 30. A column 503 indicates the data transmission source, wherein “browser” and “emu” represent data input via the browser input and output unit 14 (i.e., the browser screen) and the emulator input and output unit 13 (i.e., the emulator screen) of the terminal 10, respectively, and “rsv sys” represents data received from the reservation system 21. Columns 504 to 515 store sets of entry names and descriptions of the data. The columns 504, 506, 508, 510, 512, and 514 store the entry names of the data, and the columns 505, 507, 509, 511, 513, and 515 store the descriptions associated with the entry names stored in the left adjacent columns. For example, with respect to line number “1”, the column 504 indicates that the entry name of the data is “departure”, and the description of the data is “Haneda” stored in the column 505.

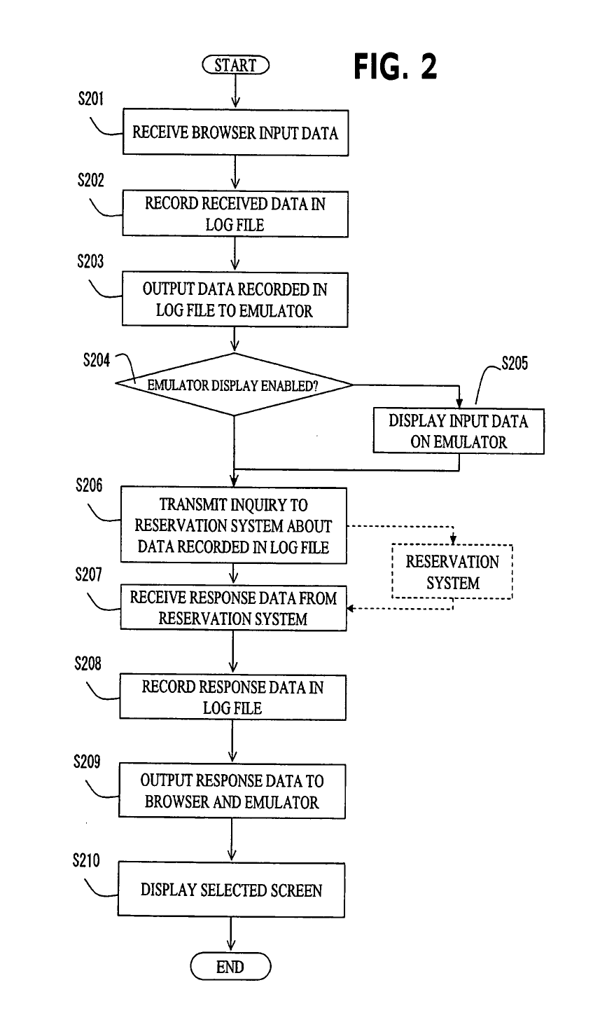

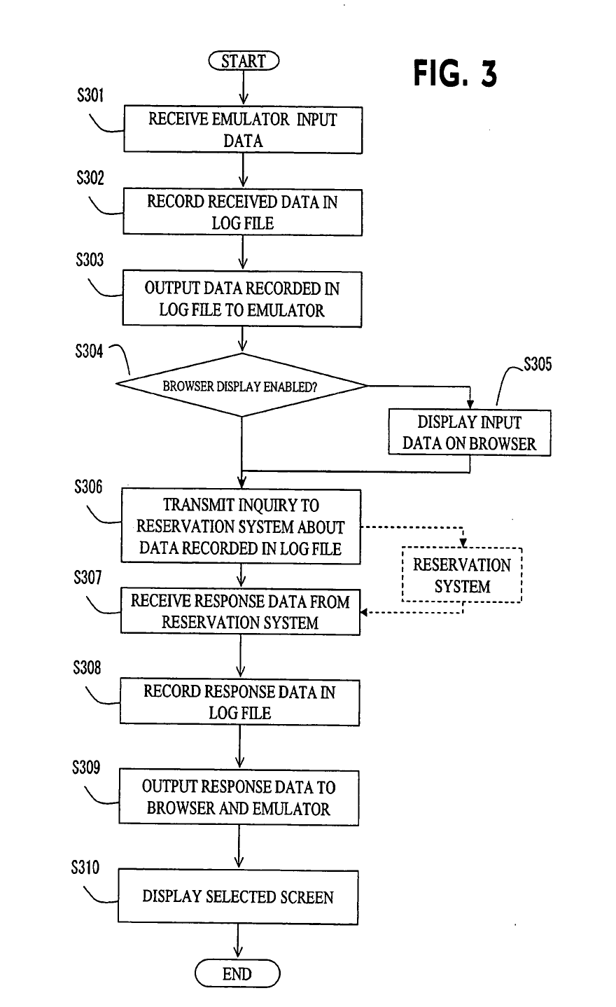

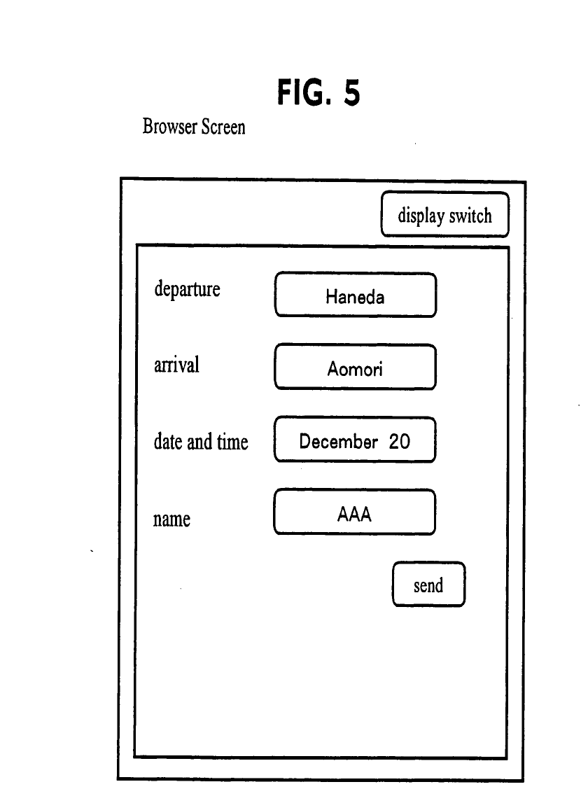

The details of processes according to the present invention will be described hereinbelow with reference to flowcharts shown in FIGS. 2 and 3 and display screen views shown in FIGS. 5 to 10.

FIG. 2 is a flowchart showing a process for submitting an inquiry to the reservation system 21 and displaying response data on the terminal 10 based on data input by a user from the browser screen.

In step S201, data input from the browser screen is received. A display screen displayed at this time is shown in FIG. 5. In FIG. 5, “Haneda” is entered in a “departure” data entry field, “Aomori” is entered in an “arrival” data entry field, “December 20” is entered in a “date and time” data entry field, and “AAA” is entered in a “name” data entry field. That is, on this screen, user AAA is to perform an inquiry about the availability of a flight departing from Haneda and arriving in Aomori on December 20. When the user operates a “send” button, the entries are set. The input data is transmitted to the data management communication unit 15, and the subsequent operation is performed in the terminal 10. When a “display switch” is operated in FIG. 5, the display screen controller 12 selects which display screen is to be displayed on the display device, and outputs the selected screen to the display unit 11. There are three screen switching modes: a browser screen mode in which the browser screen is displayed, an emulator screen mode in which the emulator screen is displayed, and a dual-screen mode in which both the browser screen and the emulator screen are displayed. In the example shown in FIG. 5, only the browser screen is selected.

In step S202, the input data is recorded in the log file 16. That is, the input data received by the data management communication unit 15 in step S201 is recorded in the log file 16. The recording of the input data is shown in line number “1” in the column 501 in log file status 1 shown in FIG. 4A. At this time, line number “2” in the column 501 does not exist.

In step S203, the input data recorded in the log file 16 is output to the emulator input and output unit 13. Specifically, the data recorded in the log file 16 in step S202 is stored in the display data storage unit 131 in the emulator input and output unit 13. This processing is performed irrespective of whether or not the emulator screen mode is set.

In step S204, the display screen controller 12 determines whether or not the emulator screen mode is set. If the emulator screen mode is set, the process proceeds to step S205.

In step S205, the input data stored in the display data storage unit 131 in step S203 is displayed on the emulator screen. For example, command line “R Haneda Aomori 1220 AAA” is displayed on the emulator screen. The symbol “R” is a command for submitting an inquiry to the reservation system 21.

The data management communication unit 15 submits an inquiry to the reservation system 21 based on the input data in step S206, and receives response data to the inquiry in step S207.

In step S208, the response data received in step S207 is recorded in the log file 16. The log file status at this time is shown in FIG. 4A. The data recorded in step S208 is shown in line number “2” in the column 501. This data is response data, as indicated by the “response” entry in the column 502, and is data from the reservation system 21, as indicated by the “rsv sys” entry in the column 503. The columns 504 and 505 indicate that the description of the “flight number” data entry field shows “A111”, the columns 506 and 507 indicate that the description of the “date” entry field shows “1220”, the columns 508 and 509 indicate that the description of the “time” entry field shows “1100”, the columns 510 and 511 indicate that the description of the “departure” data entry field shows “Haneda”, the columns 512 and 513 indicate that the description of the “arrival” data entry field shows “Aomori”, and the columns 514 and 515 indicate that the description of the “availability” data entry field shows “vacant”.

In step S209, the response data is output to the browser input and output unit 14 and the emulator input and output unit 13. Specifically, the response data recorded in the log file unit 16 in step S208 is stored in the display data storage units 141 and 131 of the browser input and output unit 14 and the emulator input and output unit 13, respectively. This processing is performed irrespective of which screen mode is set in the display screen controller 12.

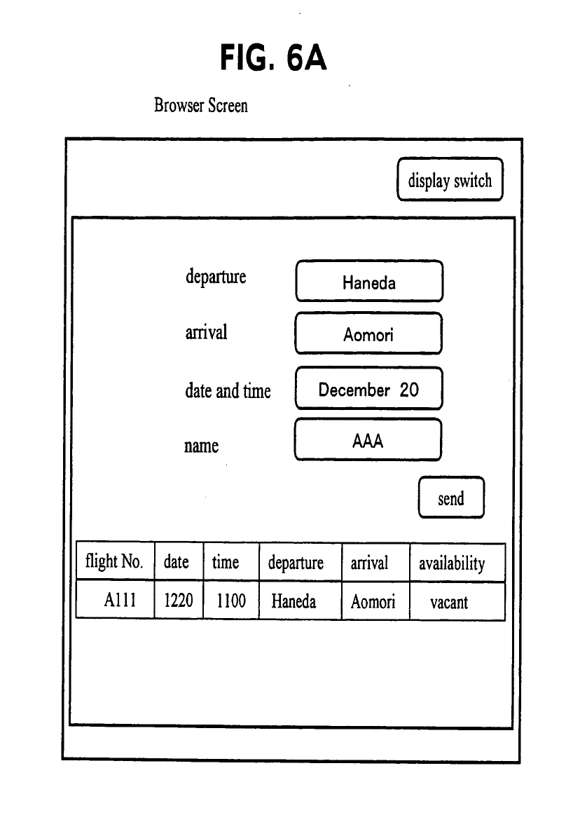

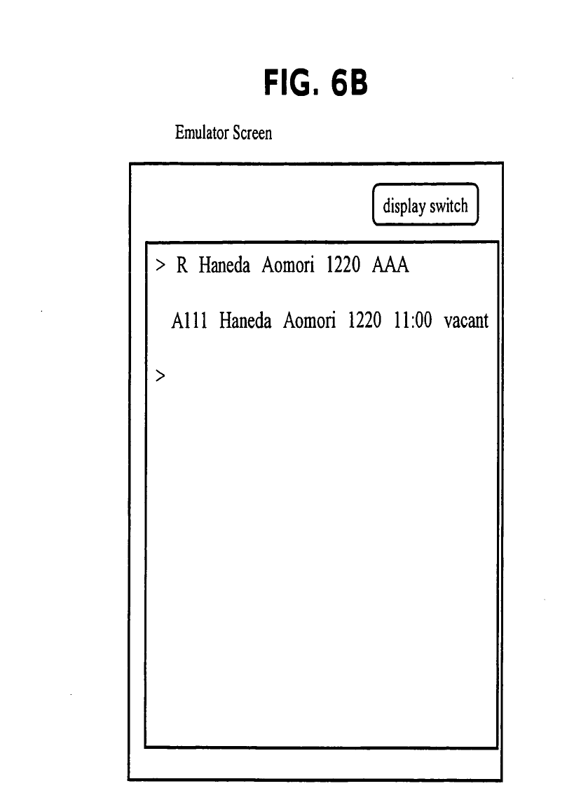

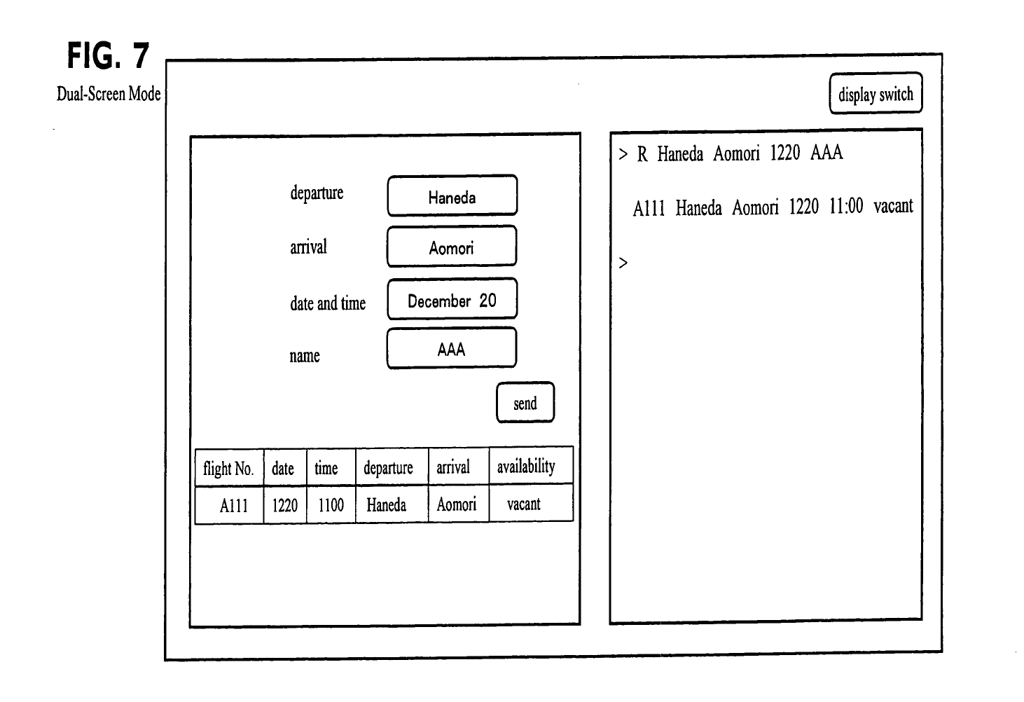

In step S210, the screen selected by the display screen controller 12 is output to and displayed on the display unit 11. Specifically, when the screen mode is set to the browser screen mode, the entries of the response data recorded in line number “2” in the log file 16 are displayed according to the format specified by the HTML definition file 17, as indicated in a lower portion of a browser screen shown in FIG. 6A. When the screen mode is set to the emulator screen mode, as indicated in the second line in an emulator screen shown in FIG. 6B, the entries of the response data recorded in line number “2” in the log file 16 are displayed as “A111 Haneda Aomori 1220 11:00 vacant”. When the dual-screen mode in which both the browser screen and the emulator screen are displayed is set, a view shown in FIG. 7 is displayed.

The three display screen modes may be set at any stage during the operation and during the process. For example, when only the browser screen shown in FIG. 6A is displayed, if the display screen controller 12 changes the screen mode to the emulator screen mode, the emulator input and output unit 13 generates emulator-screen display data by converting the entries stored in the display data storage unit 131 into the emulator screen display format, and transmit the emulator-screen display data to the display screen controller 12. The display screen controller 12 outputs the emulator-screen display data received from the emulator input and output unit 13 to the display unit 11, and the screen shown in FIG. 6B is displayed. When the emulator screen mode is changed to the browser screen mode, also, the browser input and output unit 14 generates browser-screen display data by converting the entries stored in the display data storage unit 141 into the format specified by the HTML definition file 17, and transmits the browser-screen display data to the display screen controller 12. The display screen controller 12 outputs the browser-screen display data received from the browser input and output unit 14 to the display unit 11, and the screen shown in FIG. 6A is displayed. When the screen mode is changed to the dual-screen mode in which both screens are simultaneously displayed, similar processing is performed. That is, in step S203 or S209, data input to the terminal 10 or data received from the outside via the network 30, e.g., response data received from the reservation system 21, is stored in the log file 16 irrespective of which screen mode is set, and is also stored in the display data storage units 131 and 141 for screen mode switching.

FIG. 3 is a flowchart showing a process for submitting an inquiry to the reservation system 21 and displaying response data on the terminal 10 based on data input by a user from the emulator screen.

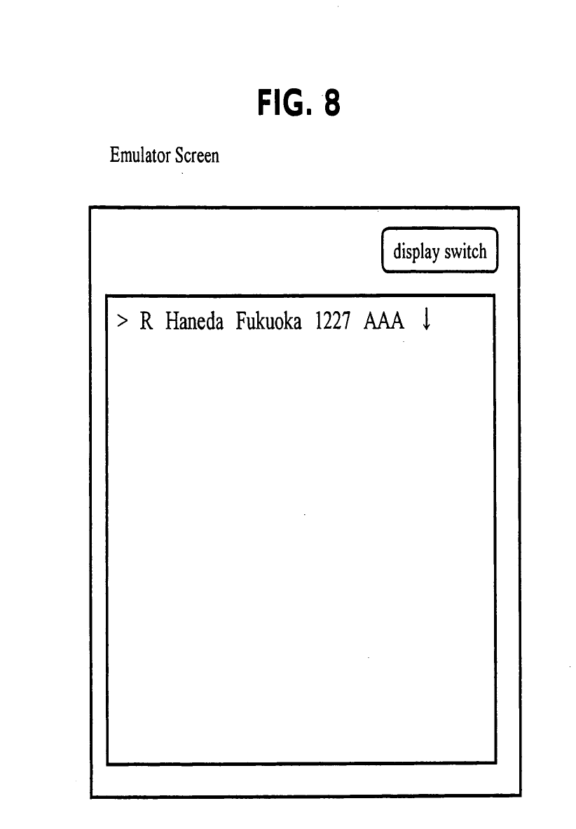

In step S301, data input from the emulator screen is received. A display screen displayed at this time is shown in FIG. 8. In FIG. 8, “R”, “Haneda”, “Fukuoka”, “1227”, and “AAA” are entered by the user. The symbol “R” is a command for submitting an inquiry to the reservation system 21. On the screen shown in FIG. 8, user AAA is to perform an inquiry about the availability of a flight departing from Haneda and arriving in Fukuoka on December 27. When a “return” is operated, the entries are set, and the input data is transmitted to the data management communication unit 15. When a “display switch” is operated in FIG. 8, the display screen controller 12 selects which display screen is to be displayed on the display device, and outputs the selected screen to the display unit 11. That is, the screen mode can be switched to a browser screen mode in which the browser screen is displayed, an emulator screen mode in which the emulator screen is displayed, or a dual-screen mode in which both screens are displayed. In the example shown in FIG. 8, only the emulator screen is selected.

In step S302, the input data is recorded in the log file 16. That is, the input data received by the data management communication unit 15 in step S301 is recorded in the log file 16. The recording of the input data is shown in line number “3” in the column 501 in log file status 2 shown in FIG. 4B. At this time, line number “4” and the following lines in the column 501 do not exist.

In step S303, the input data recorded in the log file 16 is output to the browser input and output unit 14. Specifically, the data recorded in the log file 16 in step S302 is stored in the display data storage unit 141 in the browser input and output unit 14. This processing is performed irrespective of whether or not the browser screen mode is set.

In step S304, the display screen controller 12 determines whether or not the browser screen mode is set. If the browser screen mode is set, the process proceeds to step S305.

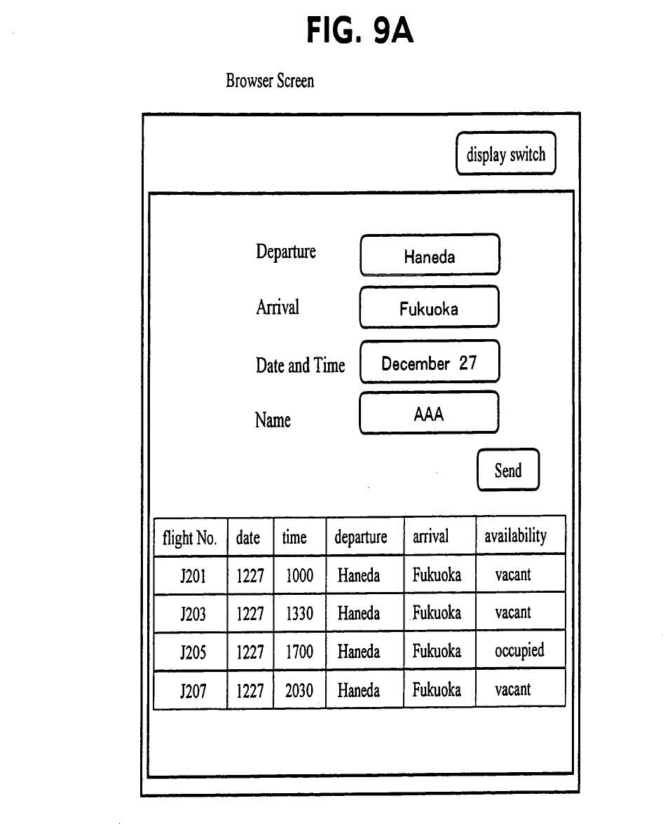

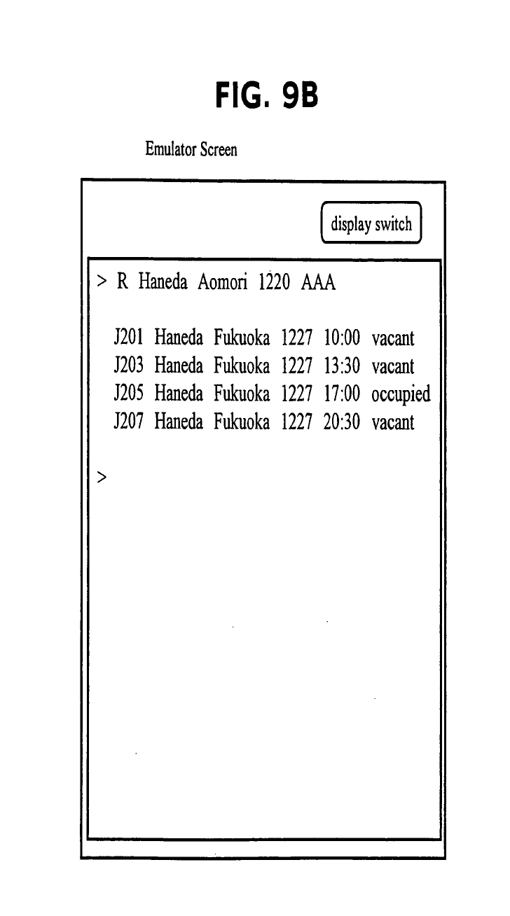

In step S305, the input data stored in the display data storage unit 141 in step S303 is displayed on the browser screen. For example, a browser screen shown in FIG. 9A without the lower portion thereof, that is, a browser screen on which “Haneda”, “Fukuoka”, “December 27”, and “AAA” are entered in “departure”, “arrival”, “date”, and “name” fields, respectively, is displayed.

The data management communication unit 15 submits an inquiry to the reservation system 21 based on the input data in step S306, and receives response data to the inquiry in step S307.

In step S308, the response data received in step S307 is recorded in the log file 16. The log file status at this time is shown in FIG. 4B. The data recorded in step S308 is shown in line numbers “4” to “7” in the column 501. For example, the response data recorded in line number “4” in the column 501 is response data, as indicated by the “response” entry in the column 502, and is data received from the reservation system 21, as indicated by the “rsv sys” entry in the column 503. The columns 504 and 505 indicate that the description of the “flight number” data entry field shows “J201”, the columns 506 and 507 indicate that the description of the “date” data entry field shows “1227”, the columns 508 and 509 indicate that the description of the “time” data entry field shows “1000”, the columns 510 and 511 indicate that the description of the “departure” data entry field shows “Haneda”, the columns 512 and 513 indicate that the description of the “arrival” data entry field shows “Fukuoka”, and the columns 514 and 515 indicate that the description of the “availability” data entry field shows “vacant”.

In step S309, the response data is output to the browser input and output unit 14 and the emulator input and output unit 13. This processing is similar to the processing of step S209.

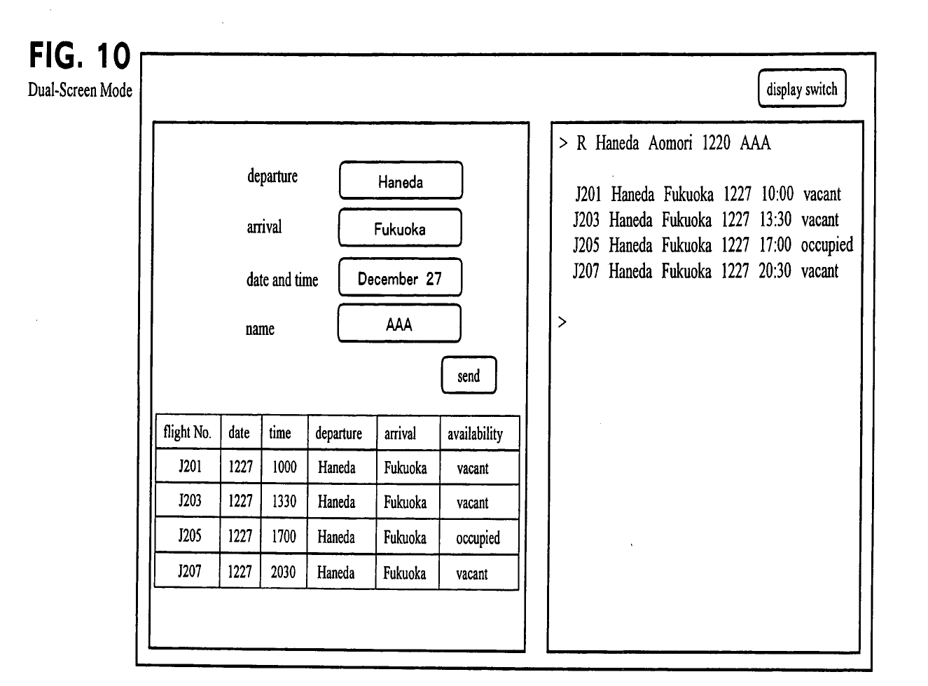

In step S310, the screen selected by the display screen controller 12 is output to and displayed on the display unit 11. Specifically, when the screen mode is set to the browser screen mode, the entries of the response data recorded in line numbers “4” to “7” in the log file 16 are displayed according to the format specified by the HTML definition file 17, as indicated in the lower portion of the browser screen shown in FIG. 9A. When the screen mode is set to the emulator screen mode, as indicated in the second and following lines in an emulator screen view shown in FIG. 9B, the entries of the response data recorded in line numbers “4” to “7” in the log file 16 are displayed as “J201 Haneda Fukuoka 1227 10:00 vacant”, “J203 Haneda Fukuoka 1227 13:30 vacant”, “J205 Haneda Fukuoka 1227 17:00 occupied”, and “J207 Haneda Fukuoka 1227 20:30 vacant”. When the dual-screen mode in which both the browser screen and the emulator screen are displayed is set, a view shown in FIG. 10 is displayed.

The process for inputting and outputting data with two screens according to the present invention has been described.

The terminal 10 and the host server 20 are computers the entirety of which is controlled by a central processing unit (CPU), although not shown. The CPU is connected with a random access memory (RAM), a hard disk drive (HDD), a graphic processor, an input interface, a communication interface, etc., via a bus.

The RAM temporarily stores a program of an operating system (OS) executed by the CPU or at least a portion of other programs. The RAM also stores various types of data necessary for the processing by the CPU. The HDD stores the OS, other programs, and data.

A monitor device is connected to the graphic processor. The graphic processor allows an input screen or the like to be displayed on the monitor according to an instruction from the CPU. A keyboard, a mouse, etc., are connected to the input interface. The input interface transmits a signal sent from the keyboard, the mouse, etc., to the CPU via the bus.

The communication interface is connected to the network 30. The communication interface transmits and receives data between the terminal 10 and the host server 20 via the network 30.

A program for inputting and outputting data with two screens according to the present invention is executed by the computer, thereby implementing the computer as an apparatus for inputting and outputting data with two screens.

The processing of the functions of the computer can be described in a program recorded on computer-readable recording media. This program is executed by a computer, thereby implementing the processing on the computer. The computer-readable recording media include a magnetic recording device and a semiconductor memory. The program may be distributed to the market by storing the program in portable recording media such as a CD-ROM (Compact Disk Read Only Memory) and a flexible disk or by storing it in a storage device of a computer connected via a network and transferring it to another computer over the network. When the program is executed by a computer, the program is stored in a built-in hard disk drive or the like of the computer, and is loaded to a main memory for execution.

The present invention is not limited to the embodiment disclosed in this document, and a variety of modifications and changes may be made without departing from the scope of the invention.

The recording medium, method, and apparatus set forth in Appendix below may constitute embodiments of according to the present invention.

What is claimed is:

1. A computer readable recording medium storing a program to input and output data with first and second display screens of different types, the program, when executed, causing a computer to perform a process comprising:
a first data entry step of receiving data input from the first screen;
an input data recording step of recording the received data as input data in a log file that records input/output data; and
a second display data storage step of retrieving the input data from the log file and storing the input data as second display data in a second display data storage part that stores data to be displayed on the second screen.

2. A computer readable recording medium storing a program according to claim 1, further comprising:
an input data transmission step of transmitting the input data to other computers;
a response data reception step of receiving response data which the other computers send back in response to the input data;
a response data recording step of recording the response data in the log file; and
a display response data storage step of retrieving the response data from the log file, storing the response data as first display response data in a first display data storage part that stores data to be displayed on the first screen, and storing the response data as second display response data in the second display data storage part.

3. A computer readable recording medium storing a program according to claim 1 or 2, further comprising:
a display screen control step of selecting which to display on display means the first screen, the second screen, or both the first screen and the second screen; and
a selection display step of displaying the screen selected in the display screen control step on the display means by outputting the data stored in the first display data storage part to the first screen, by outputting the data stored in the second display data storage part to the second screen, or by outputting the data stored in the first display data storage part to the first screen and the data stored in the second display data storage part to the second screen.

4. A method for inputting and outputting data with first and second display screens of different types, comprising:
a first data entry step of receiving data input from the first screen;
an input data recording step of recording the received data as input data in a log file that records input/output data; and
a second display data storage step of retrieving the input data from the log file and storing the input data as second display data in a second display data storage part that stores data to be displayed on the second screen.

5. A method for inputting and outputting data with first and second display screens of different types according to claim 4, further comprising:
an input data transmission step of transmitting the input data to other computers;
an response data reception step of receiving response data which the other computers send back in response to the input data;
a response data recording step of recording the response data in the log file; and
a display response data storage step of retrieving the response data from the log file, storing the response data as first display response data in a first display data storage part that stores data to be displayed on the first screen, and storing the response data as second display response data in the second display data storage part.

6. A method for inputting and outputting data with first and second display screens of different types according to claim 4 or 5, further comprising:
a display screen control step of selecting which to display on display means the first screen, the second screen, or both the first screen and the second screen; and
a selection display step of displaying the screen selected in the display screen control step on the display means by outputting the data stored in the first display data storage part to the first screen, by outputting the data stored in the second display data storage part to the second screen, or by outputting the data stored in the first display data storage part to the first screen and the data stored in the second display data storage part to the second screen.

7. An apparatus for inputting and outputting data with first and second display screens of different types, comprising:
first data entry means for receiving data input from the first screen;
a log file for storing input/output data;
input data recording means for recording the received data as input data in the log file; and
second display data storage means for retrieving the input data from the log file and storing the input data as second display data in a second display data storage part that stores data to be displayed on the second screen.

8. An apparatus for inputting and outputting data with first and second display screens of different types according to claim 7, further comprising:
input data transmission means for transmitting the input data to other computers;
response data reception means for receiving response data which the other computers send back in response to the input data;
response data recording means for recording the response data in the log file; and
display response data storage means for retrieving the response data from the log file, storing the response data as first display response data in a first display data storage part that stores data to be displayed on the first screen, and storing the response data as second display response data in the second display data storage part.

9. An apparatus for inputting and outputting data with first and second display screens of different types according to claim 7 or 8, further comprising:
display screen control means for selecting which to display on display means the first screen, the second screen, or both the first screen and the second screen; and
selection display means for displaying the screen selected by the display screen control means on the display means by outputting the data stored in the first display data storage part to the first screen, by outputting the data stored in the second display data storage part to the second screen, or by outputting the data stored in the first display data storage part to the first screen and the data stored in the second display data storage part to the second screen.
